(19) United States
(12) Patent Application Publication
(10) Pub. No.: US 2026/0281587 A1
(43) Pub. Date: Sep. 17, 2026

(54) SENSOR DEVICE AND METHOD

(71) Applicant: Sony Semiconductor Solutions Corporation, Kanagawa (JP)

(72) Inventors: Tore MARTINUSSEN, Stuttgart (DE); Johannes SOLHUSVIK, Stuttgart (DE)

(73) Assignee: Sony Semiconductor Solutions Corporation, Kanagawa (JP)

(21) Appl. No.: 19/163,857

(22) PCT Filed: Mar. 20, 2024
(86) PCT No.: PCT/EP2024/057420

§ 371 Date: Sep. 10, 2025

(30) Foreign Application Priority Data
Mar. 29, 2023 (EP) 23165231.4

(51) Int. Cl. H04N 25/78; H04N 25/10; H04N 25/531; H04N 25/702

(52) U.S. Cl. CPC H04N 25/78; H04N 25/10; H04N 25/531; H04N 25/702

(57) ABSTRACT

An Imaging sensor device configured to produce image data comprising a plurality of analog-to-digital-converters, a pixel array comprising a plurality of pixels in a row and column arrangement, the pixels being of at least two different types, at least one type of pixels being a type of IR-pixels and at least one type of pixels being a type of non-IR-pixels, the types of IR-pixels being configured to primarily sense infrared light, the types of non-IR-pixels being configured to primarily sense electromagnetic radiation that is not infrared light, a connection between individual pixels and the individual analog-to-digital-converters being configured to provide a plurality of selectable channels, a first channel causing the plurality of analog-to-digital-converters to access the plurality of pixels as pixels being accessed, a second channel causing the plurality of analog-to-digital-converters to access only pixels of a type of IR-pixels as pixels being accessed.

### TECHNICAL FIELD

The present disclosure generally pertains to a sensor device and a method.

### TECHNICAL BACKGROUND

Known image sensors offer a capability to acquire image data in both a visual range of the electromagnetic spectrum and the infrared (IR) range of the electromagnetic spectrum using the same sensor. However, as pixels configured to sense light in the infrared range of the electromagnetic spectrum have a significantly lower responsivity than pixels configured to sense light in the visual range of the electromagnetic spectrum, the quality of image data in the infrared can be reduced.

Patent literature 1 describes a solid-state imaging element that includes a first substrate including a pixel circuit having a pixel array unit, and a second substrate. The second substrate includes signal processing circuits to process signals from the pixel array unit, and a wiring layer with wiring regions electrically connected to respective ones of the signal processing circuits. Each signal processing circuit has a same circuit pattern. The second substrate and the first substrate are stacked. A wiring pattern of each wiring region is different.

### LIST OF REFERENCES

Patent literature 1: United States patent application laid open US 20190104260 A1

### SUMMARY

According to a first aspect, the disclosure, as set forth in independent claim 1, provides an imaging sensor device comprising a plurality of analog-to-digital-converters, a pixel array comprising a plurality of pixels in a row and column arrangement, the pixels being of at least two different types, at least one type of pixels being a type of IR-pixels and at least one type of pixels being a type of non-IR-pixels, the types of IR-pixels being configured to primarily sense infrared light, the types of non-IR-pixels being configured to primarily sense electromagnetic radiation that is not infrared light, a connection between individual pixels and the individual analog-to-digital-converters being configured to provide a plurality of selectable channels, a first channel causing the plurality of analog-to-digital-converters to set the plurality of pixels as pixels being accessed, a second channel causing the plurality of analog-to-digital-converters to set only pixels of a type of IR-pixels as pixels being accessed.

According to a second aspect, the disclosure, as set forth in independent claim 14 provides a control method comprising setting a connection between pixels and analog-to-digital-converters to one of a plurality of channels, a first channel causing the plurality of analog-to-digital-converters to set the plurality of pixels as pixels being accessed, a second channel causing the plurality of analog-to-digital-converters to set only IR-pixels as pixels being accessed, reading a state of the pixels being accessed in order to produce image data.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 shows a general configuration of an RGB-IR imaging sensor;

FIG. 2 illustrates one aspect of the imaging sensor device according to one embodiment;

FIG. 3 shows a first embodiment of the image sensor according to the present disclosure;

FIG. 4 shows a second embodiment of the image sensor according to the present disclosure;

FIG. 5 shows one aspect of the control method according to the present disclosure according to one embodiment;

FIGS. 6a and 6b show a second aspect of the control method according to the present disclosure according to one embodiment;

FIG. 7 is a block diagram illustrating an example of schematic configuration of a vehicle control system.

FIG. 8 is a diagram illustrating an example of installation positions of an outside-vehicle information detecting section and an imaging section.

### DETAILED DESCRIPTION OF EMBODIMENTS

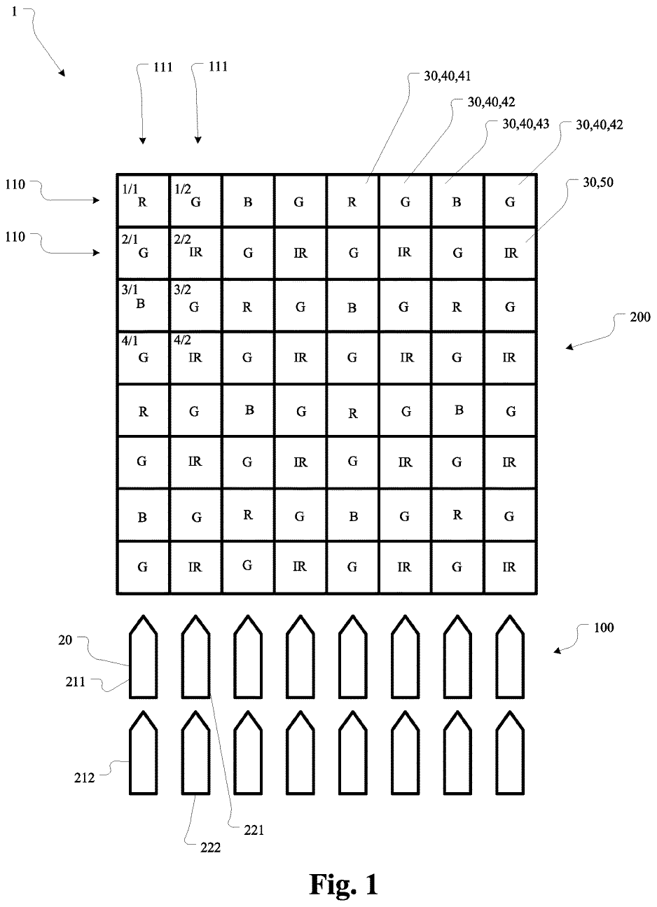

Before a detailed description of the embodiments under reference of FIG. 1 is given, general explanations are made.

An imaging sensor device according to the present disclosure comprises a plurality of analog-to-digital-converters, a pixel array comprising a plurality of pixels in a row and column arrangement, the pixels being of at least two different types, at least one type of pixels being a type of IR-pixels and at least one type of pixels being a type of non-IR-pixels, the types of IR-pixels being configured to primarily sense infrared light, the types of non-IR-pixels being configured to primarily sense electromagnetic radiation that is not infrared light, a connection between individual pixels and the individual analog-to-digital-converters being configured to provide a plurality of selectable channels, a first channel causing the plurality of analog-to-digital-converters to access the plurality of pixels as pixels being accessed, a second channel causing the plurality of analog-to-digital-converters to access only pixels of a type of IR-pixels as pixels being accessed.

The term “light” as a noun is to be understood to refer to electromagnetic radiation in the shape of electromagnetic waves or photons. The term “pixel” is to be understood as a photo sensor that returns a signal that is readable by an analog-to-digital converter that can be used, in conjunction with signals generated by a plurality of pixels, to compose image data that constitutes a digital image. In the following, the term “IR-pixel” is to be understood to denote a type od IR-pixel.

There may be more than one type of IR-pixels provided in a imaging sensor device according to the present disclosure.

The imaging sensor device can, according to the present disclosure, comprise, for example 5 million pixels (equivalent to 5 Megapixels), though a higher number of pixels or a lower number of pixels is possible. The number of IR-pixels may, for example, be 25% of the total number of pixels. The number of the ADCs is smaller than the number of pixels.

A connection may be any electronic connection that enables an electronic signal to be transferred from the pixel or pixel array to the analog-to-digital converters (ADCs). The connection includes can include switches or signal routing measures that allow the connection to be adjusted such that channels can be selected. The selection may be automatic, by an outside control method, a control unit or an electronic signal. The selection may be based on the input provided by an operator or be based on a selection algorithm implemented on an electronic device. The infrared according to the present disclosure is any electromagnetic radiation with a wavelength above 700 nm and below 1 mm, corresponding to frequencies between 428 THz and 300 GHz. This range of frequencies can be called the infrared and electromagnetic radiation in that range of frequencies can be called infrared radiation or infrared light.

The sensor can be configured to sense electromagnetic radiation in a range of frequencies or a plurality of ranges of frequencies in the infrared, or at a single frequency or at a plurality of single frequencies in the infrared. Or different types of IR-pixels, each sensitive to a particular range of frequencies or single frequencies, may be provided. Infrared radiation is, for example, radiation emitted by objects containing a significant amount of heat, specifically infrared radiation can be emitted by humans or animals due to their natural body heat. For example, the pixels may be MOSFET (metal-oxide semiconductor field-effect transistor) devices. The IR-pixels may be shielded against non-IR light. The pixels may be provided in an array configuration. The array may be arranged in a row-and-column arrangement with pixels, in a plane, arranged in a chequerboard fashion facing, on one side, the incident light. The pixel array can constitute a CMOS or CCD type sensor.

In some embodiments of the present disclosure, the diversity of types of pixels further comprises a plurality of types of visual pixels, the types of visual pixels being configured to sense visual light. The pixel array comprises IR-pixels, configured primarily to sense infrared light and pixels configured to primarily not sense infrared light. The pixels configured to primarily sense not infrared light may be configured to primarily sense visual light.

The pixels to primarily sense visual light may be called visual pixels. The visual pixels according to the present disclosure can be any light-sensitive sensor that may be used in order to sense electromagnetic radiation in the visual and whose state can be read using an ADC. The visual according to the present disclosure is any electromagnetic radiation in the range of frequencies normally accessible to human vision. The range of frequencies normally accessible to human vision can be called the visual and electromagnetic radiation in that range of frequencies can be called visual light.

In some embodiments of the present disclosure the types of visual pixels comprise a red type, configured to sense a red component of visual light, a green type, configured to sense a green component of visual light and a blue type, configured to sense a blue component of visual light, as RGB pixels. Red-type pixels can be configured to be sensitive to a red component of visual light. Green-type pixels can be configured to be sensitive to a green component of visual light.

Blue-type pixels can be configured to be sensitive to a blue component of visual light. This can constitute an RGB-type sensor corresponding to an RGB color-scheme. Different sensitivities can, for example, be implemented using a Bayer-filter arrangement applied to the pixel array that shields pixels from light at different frequencies, though other methods are possible. For example, the visual pixels may be shielded against non-visual light.

In some embodiments of the present disclosure the connection comprises wires. Wires are a physical electronic connection that allow a charge or current to be transmitted. The wires may also be conductive features or layers in a semiconductor devices or circuitry.

Some embodiments of the present disclosure provide for each analog-to-digital-converter to be cross-connected to pixels in at least two adjacent columns of pixels. The pixels being provided in a row-and-column arrangement, each ADC can be associated with a particular column of pixels. A cross-connection, being a connection that is cross-connected between two adjacent columns of pixels, allows ADCs associated with a particular column to access pixels in the adjacent column. The pixels in the adjacent column being accessed through the cross-connection may be IR-pixels.

In some embodiments of the present disclosure provide for the connection to further comprise switches, a channel of the plurality of selectable channels determining a state of the switches and the state of the switches setting the pixels being accessed. A switch is any electronic device capable of direction the flow of a current based on an outside signal. A switch may, for example, be a transistor. The switches are configured such that the connection allows, depending on the state of the switches, the ADCs to access either all pixels or IR-pixels only.

In some embodiments of the present disclosure the pixels in at least two different columns of pixels comprise at least one type of IR-pixels and one type of non-IR-pixels. Thus, IR-pixels and non-IR pixels may be interspersed.

Some embodiments of the present disclosure provide for the connection to further comprise a plurality of multiplex devices, a channel of the plurality of selectable channels determining a state of the multiplex devices and the state of the multiplex devices setting the pixels being accessed. A multiplex device can also be called a multiplexer, a mux or a multiplexor, and is any device that selects between several analog or digital input signals received, for example, through wires, and forwards selected input signals to a smaller number output wires, the selection being directed by a separate set of inputs. The switches are configured such that the connection allows, depending on the state of the switches, the ADCs to access either all pixels or IR-pixels only.

Some embodiments of the present disclosure further provide for each individual multiplex device to be connected to an associated cell of analog-to-digital-converters, each associated cell of analog-to-digital-converters comprising an even number of at least four analog-to-digital-converters and each analog-to-digital-converter comprising an associated cell of analog-to-digital-converters being connected to the output of the multiplex device in a parallel arrangement. Thus, in one embodiment, four ADCs are connected to a single multiplex-device on the output side.

Some embodiments of the present disclosure further provide for each individual multiplex device to be connected to an associated bundle of wires, each associated bundle of wires comprising a number of wires that is twice the number of analog-to-digital-converters constituting the associated cell of analog-to-digital-converters. Thus, the input received by the multiplex device from the connection on the input side is transferred to the ADCs on the output side.

Some embodiments of the present disclosure further provide for the associated bundle of wires to be connected to pixels in a number of columns, the number of columns being half the number of analog-to-digital-converters constituting the associated cell of analog-to-digital-converters, the columns being adjacent to each other. Thus, by setting the state of the multiplex devices, the wires being connected to the pixels, depending on the state of the multiplex devices, the ADCs can access either all pixels or IR-pixels only.

Some embodiments of the present disclosure further provide for the plurality of analog-to-digital-converters to be configured to read a state of the pixels being accessed in a sequence column-by-column row-by-row. Here, if only IR-pixels are being accessed, non-IR pixels can be skipped, leading to a smaller number of pixels requiring to be read by the same number of ADCs. This way, the time required to acquire an image in the infrared can be reduced by only reading IR-pixels compared to the time required to acquire an image in, for example, the visual and the infrared by reading all pixels. Reading only IR-pixel accordingly can be equivalent to skipping 2×2 pixels, thus reducing the frame time.

The term “row-by-row” is to be understood that one row or a set of rows comprising multiple adjacent rows, is read and subsequently an adjacent row or an adjacent set of rows that has not been read is read. The term “column-by-column” is to be understood that one column or a set of columns comprising multiple adjacent columns, is read and subsequently an adjacent columns or an adjacent set of columns that has not been read is read. The term “column-by-column and row-by-row” is to be understood that one row or a set of rows comprising multiple adjacent rows is accessed and all columns in the row or set of rows are fully read column-by-column and then an adjacent row or set of rows is accessed and all columns in the row or set of rows are fully read column-by-column until all rows have been read.

Some embodiments of the present disclosure further provide for the sequence to constitute a rolling shutter procedure. Known methods for acquiring an IR-image with a short frame time utilize a global shutter procedure. The device according to the present disclosure can achieve comparable frame times using a rolling shutter procedure. The achievable frame time can be equivalent to a shutter time of 1.25 ms. If the imaging sensor device according to the present disclosure is used to generate video data, this can be equivalent to a frame rate of 800 frames per second. If only the IR-pixels are read, the energy requirements of the imaging sensor device can be reduced.

Some embodiments of the present disclosure further provide for the plurality of selectable channels to include a channel that causes the plurality of analog-to-digital-converters to access only a subset of the plurality of pixels as pixels being accessed, the subset of the plurality of pixels comprising no types of IR-pixels, or the subset of the plurality of pixels comprising types of IR-pixels and types of non-IR-pixels.

A subset can be only a part of the pixel arrangement, such as contiguous segment. This results in a smaller image, but can be used if only part of the image is deemed to be interesting and can further improve the frame time and lower the energy requirements. A subset can also be a sparse subset of the pixel arrangement as would be produced by reading, for example, only every second row and every second column. This results in a reading at lower resolution, but can further improve the frame time and lower the energy requirements.

For example an image may be acquired at a high resolution using all available pixels, followed by an image at lower resolution or a picture segment that uses only a subset of all available pixels. Alternatively, an image may be acquired at a high resolution using all available IR-pixels followed by an image at lower resolution or a picture segment that uses only a subset of all available IR-pixels.

A control method according to the present disclosure comprises setting a connection between pixels and analog-to-digital-converters to one of a plurality of channels, a first channel causing the plurality of analog-to-digital-converters to access the plurality of pixels as pixels being accessed, a second channel causing the plurality of analog-to-digital-converters to access only IR-pixels as pixels being accessed, and reading a state of the pixels being accessed to produce image data. The setting may be automatic, by an outside control method, a control unit or an electronic signal. The setting may be based on the input provided by an operator or be based on a selection algorithm implemented on an electronic device. The setting may depend on which type of light a sensor assembly is required to detect. The setting may depend on a particular application of the image data generated by the imaging sensor device. For example, the first channel may be used during daytime or in bright lighting conditions. The second channel may be used during night time to acquire IR-imagery of animals or humans or other objects emitting heat radiation. The imagery may be used in detecting objects, humans or animals manually or automatically. The imagery may be evaluated automatically using a naï ve algorithm or through machine learning.

Imaging assembly including the imaging sensor device according to claim 1. An imaging assembly may be an imaging unit included in a handheld imaging device, such as a camera, a generic image sensor, a video capturing device, a telescope, a mobile phone or mobile device, a security camera or a camera intended for wildlife photography. An imaging assembly may also be an imaging unit included in an image or video capturing device intended for medical use, or a an imaging unit included in a diagnostical apparatus for mechanical repair. An imaging assembly may also be an imaging unit included in an image or video capturing device intended for medical or in a mobile or stationary computer. The technology according to the present disclosure may also be otherwise implemented video capturing device, a telescope, a mobile phone or mobile device, a security camera or a camera intended for wildlife photography and other types of image capturing devices or devices including image or video capturing means. The imaging assembly may also be used wearable devices, such as augmented reality glasses, head-mounted displays or virtual reality devices. The imaging device may be used for machine vision.

Vehicle including the imaging assembly according to claim 19. The technology according to an embodiment of the present disclosure is applicable to various products. For example, the technology according to an embodiment of the present disclosure may be implemented as a device included in a mobile body that is any of kinds of automobiles, electric vehicles, hybrid electric vehicles, motorcycles, bicycles, personal mobility vehicles, airplanes, drones, ships, robots, construction machinery, agricultural machinery (tractors), and the like. The

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, an RGB-IR imaging sensor device 1 comprises a pixel array 200 that comprises a plurality of pixels 30. The pixel array 200 can be configured, for example, in a row-and-column pattern arrangement, wherein pixels 30 are arranged in rows 110 and columns 111. All rows 110 and columns 111, even if not specifically labelled, should be understood as rows and columns. All pixels 30, even if not specifically labelled, should be understood as pixels 30. The imaging sensor device further comprises a plurality of analog-to-digital converters (ADCs) 20, in a ADC-array 100, which may be provided in a two-floor arrangement. The pixel array 200 comprises at least two different types of pixels 30, one type being IR-pixels 50. The types of pixels 30 may, in a non-limiting example, comprise four types of pixels 30. One type of pixels 30 are IR-pixels 50 (also denoted “IR” in FIG. 1).

Another type of pixels 30 are non-IR pixels, which can be visual pixels 40. In the non-limiting example shown in FIG. 1, the visual pixels 40 comprise three types of pixels, namely red-type pixels 41 (also denoted “R” in FIG. 1), green-type pixels 42 (also denoted “G” in FIG. 1) and blue-type pixels 43 (also denoted “B” in FIG. 1). In the following, an IR-pixel is to be understood as a type of IR-pixel. The arrangement of pixels 30 in the pixel array 200 in the imaging sensor device 1 according to the present disclosure may differ from the illustration in FIG. 1. For example, a different number of pixels 30 may be provided, the pixels 30 may be arranged in a arrangement other than a row-and-column pattern, the ratio of IR-pixels 50 to visual pixels 40, the ratio of IR pixels 50 to red-type pixels 41, to green-type pixels 42 or to blue-type pixels 43 may differ, the ratio of red-type pixels 41, green-type pixels 42 and blue-type pixels 43 to each other may differ, or a relative location of the types of pixels 30 to each other may differ. The IR-pixel 40, as shown in FIG. 1, can be understood to be an IR-type pixel. There may be more than one type of IR-pixels provided in a imaging sensor device according to the present disclosure.

Furthermore, one or two of the visual pixels 40 shown in FIG. 1 may be omitted or additional types of visual pixels may be provided.

The IR-pixels 50 according to the present disclosure can be any light-sensitive sensor that may be used in order to sense electromagnetic radiation in the infrared and whose state can be read using an ADC 20. The infrared according to the present disclosure is any electromagnetic radiation with a wavelength above 700 nm and below 1 mm, corresponding to frequencies between 428 THz and 300 GHz. This range of frequencies can be called the infrared and electromagnetic radiation in that range of frequencies can be called infrared radiation or infrared light. The sensor can be configured to sense electromagnetic radiation in a range of frequencies or a plurality of ranges of frequencies in the infrared, or at a single frequency or at a plurality of single frequencies in the infrared, or different types of IR-pixels 50, each sensitive to a particular range of frequencies or single frequencies, may be provided.

Infrared radiation is, for example, radiation emitted by objects containing a significant amount of heat, specifically infrared radiation can be emitted by humans or animals due to their natural body heat. The visual pixels 40 according to the present disclosure can be any light-sensitive sensor that may be used in order to sense electromagnetic radiation in the visual and whose state can be read using an ADC 20. The visual according to the present disclosure is any electromagnetic radiation in the range of frequencies normally accessible to human vision. The range of frequencies normally accessible to human vision can be called the visual and electromagnetic radiation in that range of frequencies can be called visual light.

Red-type pixels 41 can be configured to be sensitive to a red component of visual light. Green-type pixels 42 can be configured to be sensitive to a green component of visual light. Blue-type pixels 43 can be configured to be sensitive to a blue component of visual light. Different sensitivities can, for example, be implemented using a Bayer-filter arrangement applied to the pixel array 200, though other methods are possible. For example, the pixels 30 may be MOSFET (metal-oxide semiconductor field-effect transistor) devices.

The ADC-array 100 may comprise the same number of ADCs 20 as IR-pixels 50 are provided in the pixel array 200. A different number of ADCs 20, corresponding to the same number of IR-pixels 50, is possible according to the present disclosure. Some embodiments may comprise a different ratio of ADCs 20 to IR-pixels 50.

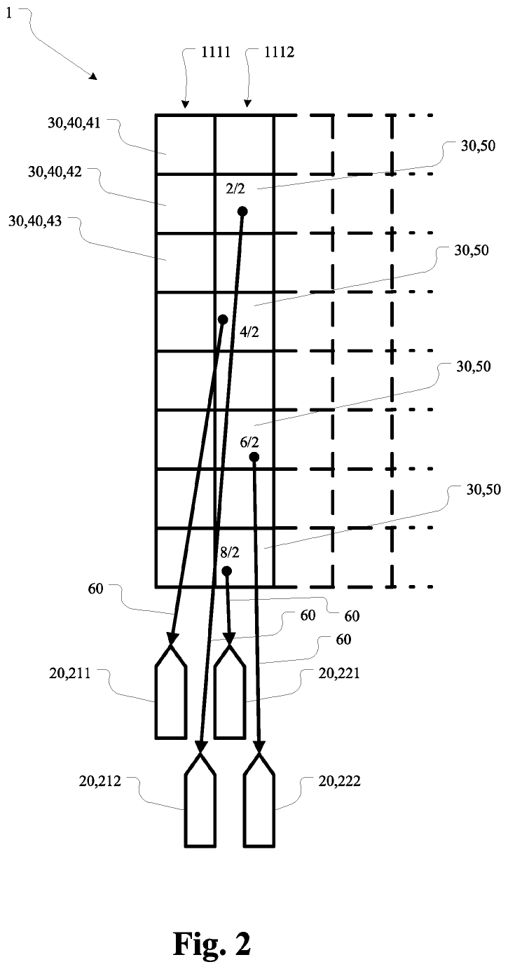

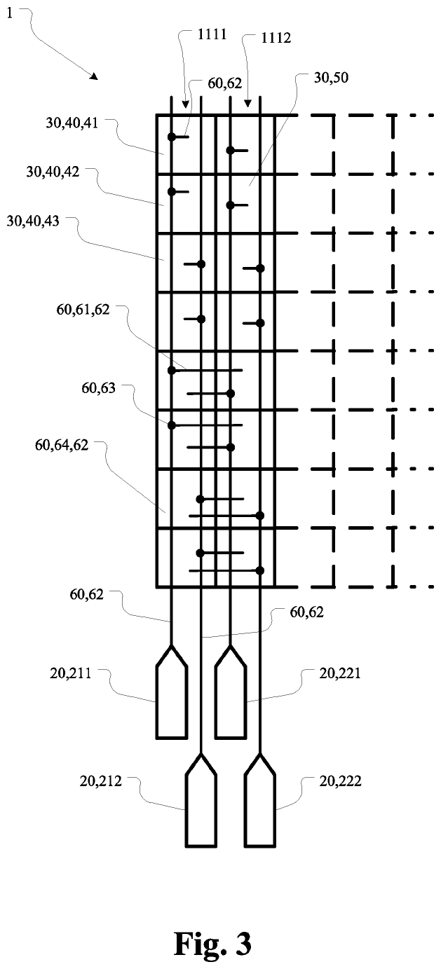

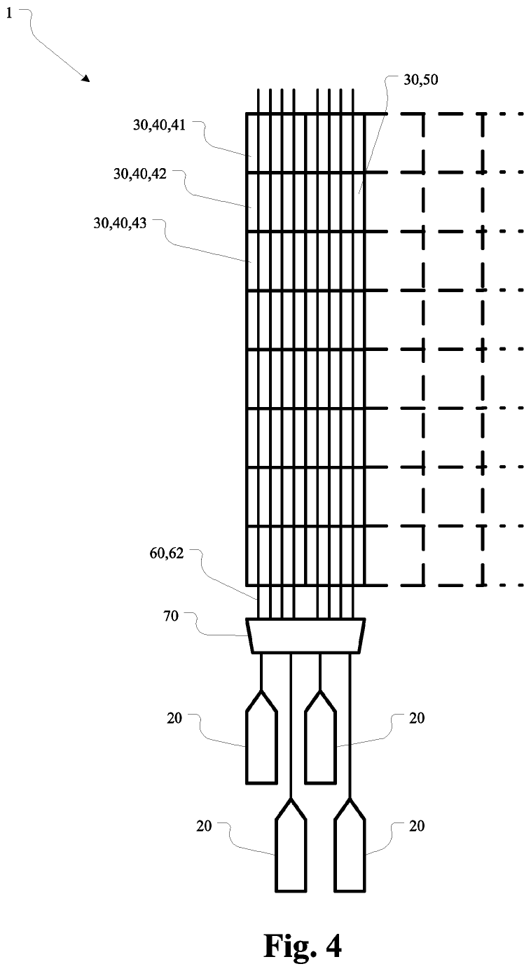

The imaging sensor device 1 can, according to the present disclosure, comprise, for example 5 million pixels 30 (equivalent to 5 Megapixels), though a higher number of pixels 20 or a lower number of pixels 20 is possible. The pixels are to be understood to be provided, for example, in a row-and column arrangement with an appropriate number of rows 110 and columns 111 and an appropriate number of ADCs 20, for example twice or higher multiples of the number of columns, in the ADC-array 100. The pixel array 200 can, if a larger number of pixels 30 than shown in FIG. 1, FIG. 2, FIG. 3 and FIG. 4, is to be provided, comprise a larger, appropriate, number of rows 110 and columns 111 and an appropriate number of ADCs 20, for example twice or higher multiples of the number of columns. The number of IR-pixels may, for example, be 25% of the total number of pixels.

The ADCs 20 are connected to the pixel array 200 such that a rolling-shutter procedure can be used to read the state of all pixels 30 in order to produce image data of an image as observed by the imaging sensor device 1 in the infrared and the visual in a first selectable channel, which may be called a full spectrum channel. The ADCs 20 are further connected to the pixel array 200 such that a rolling-shutter procedure can be used to read the state only of IR-pixels 50 in order to produce image data of an image as observed by the imaging sensor device 1 only in the infrared in a second selectable channel, which may be called an IR-only channel, as described hereinbelow. If an image is acquired in the full spectrum (visual and infrared), the ADCs 20 access the pixel array 200 column-by-column and row-by-row, top to bottom, using, for example, switches (not shown) until the state of all pixels has been read. If the number of rows 110 is larger than shown for example in FIG. 1, the procedure is repeated until all rows have been read. Alternatively, a larger number of ADCs can be provided Prior to being read, each pixel 30 constituting the pixel array 200 is sequentially or simultaneously exposed to incident radiation for a duration of an exposure time. Subsequent to being read, each pixel 30 constituting the pixel array 200 may be exposed again to produce another set of image data. ADCs 20 corresponding to a certain column may be used to read pixels 30 in that column.

For example, an ADC 211 is used to read a pixel 1/1 in a first row and simultaneously, an ADC 212 is used to read a pixel 2/1 in a second row. Subsequently an ADC 221 is used to read a pixel 1/2 and simultaneously, an ADC 222 is used to read a pixel 2/2 (pixel 2/2 being an IR-pixel 50) and so on. Once all columns are read, the ADC 211 is used to read a pixel 3/1, while, simultaneously, the ADC 212 is used to read pixel a 4/1. Then ADC 221 is used to read a pixel 3/2 and simultaneously, an ADC 222 is used to read a pixel 4/2 and so on, until all pixels 30 have been read. This results in image data corresponding to one image frame both the visual and the infrared. One image frame is to be understood as one image as acquired by reading all pixels 30 in the pixel array 200 once. As the required exposure for visual pixels 40 is shorter than for IR-pixels 50, the time required to read all pixels 30, a scenery captured by the imaging sensor device may have moved significantly between the point time where the first pixel 30 is read to the point in time where the last pixel 30 is read, the duration between the two mentioned points in time being a frame time. This procedure can be called a full spectrum read-mode and be understood as being associated with the full spectrum channel.

The full spectrum read-mode is equivalent to known methods.

The arrangement of the pixel-array 200 provided as an example in FIG. 1 can be assumed for the discussion of all subsequent figures, but is still to be understood as a non-limiting example.

FIG. 2 shows a connection 60 between IR-pixels 50 and ADCs 20 in one embodiment of the imaging sensor device 1 according to the present disclosure. For clarity, only two first columns 1111,1112 of the pixel array 200 are shown. Here, a connection 60 is provided to allow ADCs 20 to directly access IR-pixels 50 only. Thus, for example, the ADC 212 can be connected to pixel 2/2, which is an IR-pixel 50, the ADC 211 can be connected to pixel 4/2, which is likewise an IR-pixel 50, the ADC 221 can be connected to pixel 8/2, which is likewise an IR-pixel 50 and the ADC 222 can be connected to pixel 6/2, which is likewise an IR-pixel 50. This way, all ADCs 20 can be used to read IR-pixels 50 only, instead of, as in the full spectrum channel, all ADCs being used to read not only IR-pixels 50, but all pixels 30, including visual pixels 40.

Prior to being read, each pixel 30 constituting the pixel array 200 or, alternatively, only each IR-pixel 50, is sequentially or simultaneously exposed to incident radiation for a duration of an exposure time. Then all ADCs 20 associated with a pair of two adjacent columns 1111,1112 are used to read the IR-pixels 50 in these columns 111 simultaneously. The process is then repeated for a next pair of two adjacent columns 111 until all IR-pixels 50 in all columns 111 have been read. This procedure can be called a fast IR read-mode and be understood as being associated with the IR-only channel. Accordingly, the time required to read all IR-pixels 50 is reduced significantly, thereby reducing the frame time. The frame time for reading all IR-pixels can be reduced, for example, by a factor 4 compared to the frame time for reading all pixels 30. The connection 60 as shown in FIG. 2 can be replicated in all pairs of adjacent columns 111 across the pixel array 200. The fast IR read-mode can, for example, be equivalent to skipping 2×2 pixels.

This can be equivalent to a shutter time of 1.25 ms. If the imaging sensor device is used to generate video data, this can be equivalent to a frame rate of 800 frames per second, though higher or lower shutter times and frame rates are possible according to the present disclosure.

FIG. 3 shows a connection 60 between pixels 30, including IR-pixels 50, and ADCs 20 in one embodiment of the imaging sensor device 11 according to the present disclosure. The imaging sensor device 11 shown in FIG. 3 is to be understood as a first embodiment of the imaging sensor device 1. Again for clarity, only two first columns 1111,1112 of the pixel array 200 are shown.

Here the connection 60 comprises wires 62 and switches 63. Column wires 64 are provided for the full-spectrum channel, giving access to all pixels 30 to the ACDs 20. Cross-connection wires 61 connect ADCs 20 associated with a first column 1111 to the pixels 30 in a second column 1112 and ADCs 20 associated with the second column 1112 to the pixels 30 in the first column 1111. The IR-only channel, if selected, can determine a state of the switches 63 such that the fast IR read-mode is enabled. The full spectrum channel, if selected, can determine a state of the switches 63 such that the full-spectrum read-mode is enabled. The wires are connected to the pixels 30 such that a state of the pixels, for example a charge, can be read by the ADCs 20. The connection 60 as shown in FIG. 3 can be replicated in all pairs of adjacent columns 111 across the pixel array 200. The wires 62 can be VSL (vertical signal lines), but may also be conductive layers in a semiconductor structure.

FIG. 4 shows a connection 60 between pixels 30, including IR-pixels 50, and ADCs 20 in one embodiment of the imaging sensor device 12 according to the present disclosure. The imaging sensor device 12 shown in FIG. 3 is to be understood as a second embodiment of the imaging sensor device 1. Again for clarity, only the two first columns 1111,1112 of the pixel array 200 are shown. Here the connection 60 comprises wires 62 and multiplex devices 70. The multiplex device 70 can also be called a multiplexer 70, a mux 70 or a multiplexor 70. Four wires 62 are provided for each column 111 such that, determined by the state of the multiplex device 70, either all pixels 30 or only IR-pixels 50 are accessed by the ADCs 20. The IR-only channel, if selected, can determine a state of the multiplex devices 70 such that the fast IR read-mode is enabled. The full spectrum channel, if selected, can determine a state of the multiplex devices 70 such that the full-spectrum read-mode is enabled. The multiplex device 70 is used to selectively connect wires 62 connecting to the pixels 30 in two adjacent columns 111, for example the columns 1111,1112 shown here. The multiplex device 70 shown here connects 8 incoming wires to four outgoing wires, and is therefore an 8:4 multiplex device. However, there can be embodiments where more than two adjacent columns 111 are used, necessitating a larger number of wires and appropriate multiplex devices. The connection 60 as shown in FIG. 4 can be replicated in all pairs of adjacent columns 111 across the pixel array 200. The wires 62 can be VSL (vertical signal lines), but may also be conductive layers in a semiconductor structure.

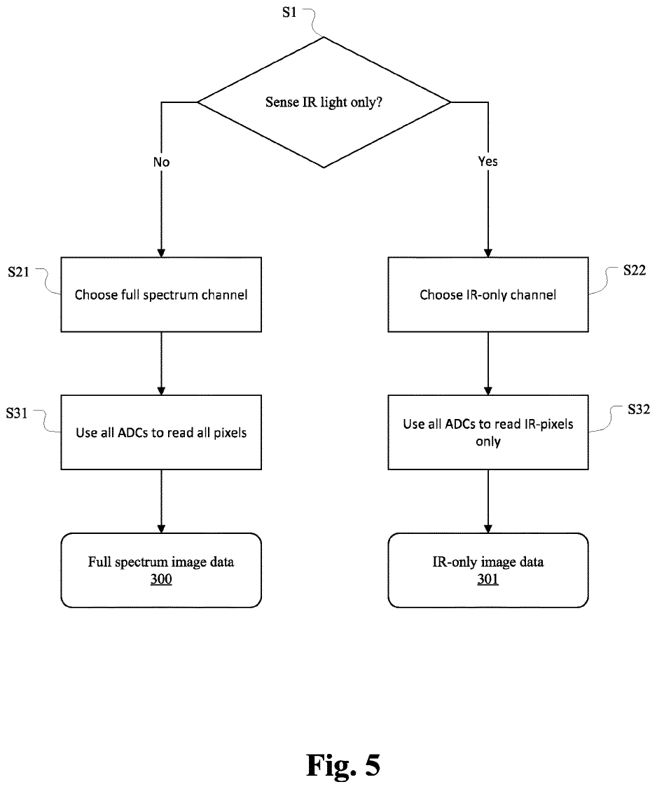

FIG. 5 shows one aspect of the control method according to one embodiment of the present disclosure. In a first step S1 a selection is provided to sense only light in the infrared. If not only IR-light is to be sensed, in a second step S21, the full spectrum channel is chosen, setting the connection 60 such that all ADCs 20 can be used to read all pixels 30 constituting the pixel array 200. In a third step S31 all ADCs are then used to read all pixels 30 constituting the pixel array 200. The ADCs 20 then generate, using the full spectrum read-mode, image data 300 corresponding to a full spectrum image as acquired by the imaging sensor device 1. If only IR-light is to be sensed, in an alternative second step S22, the full spectrum channel is chosen, setting the connection 60 such that all ADCs 20 can be used to read IR-pixels 50 included in the pixel array 200 only. In an alternative third step S32 all ADCs are then used to read IR-pixels 50 included in the pixel array 200 only. The ADCs 20 then generate, using the fast IR read-mode, image data 301 corresponding to an IR-image as acquired by the imaging sensor device 1. The image data 301 is associated with a frame time that is shorter than the frame time the image data 300 is associated with.

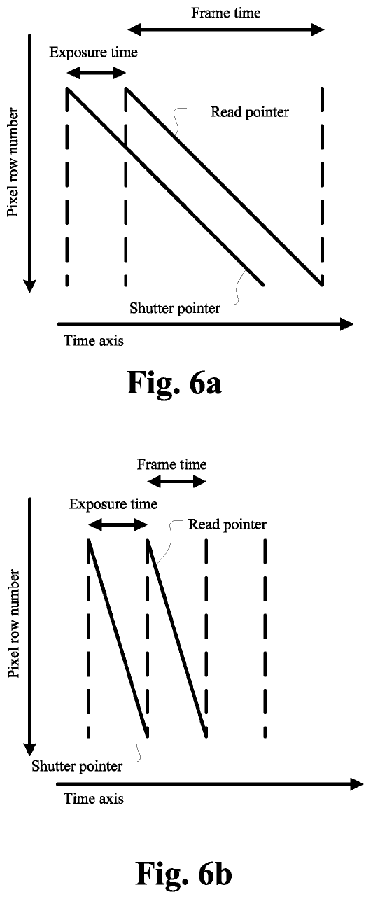

FIG. 6 shows one aspect of the control method according to one embodiment of the present disclosure. FIG. 6a shows a comparison of the exposure time with the frame time as would be expected in the full-spectrum read mode using the full-spectrum channel according to the present disclosure. The x-axis indicates a time. The y-axis indicates a pixel row number of pixels 30 being read. As illustrated in FIG. 6a, the pixel row number increases from top to bottom, but the pixel row number may also increase from bottom to top. The shutter pointer indicates a point in time at the beginning of the exposure of the pixel, the read pointer indicates a point in time when the exposure concludes and the pixel is read using the ADCs 20. FIG. 6b shows a comparison of the exposure time with the frame time as would be expected in the fast IR read mode using the IR-only channel according to the present disclosure. The x-axis, as in FIG. 6a, indicates a time.

The y-axis indicates a pixel row number of IR-pixels 50 being read. As illustrated in FIG. 6b, the pixel row number increases from top to bottom, but the pixel row number may also increase from bottom to top. The shutter pointer indicates a point in time at the beginning of the exposure of the pixel, the read pointer indicates a point in time when the exposure concludes and the pixel is read using the ADCs 20. The faster read time translates to a shorter frame time if the fast IR read-mode is used.

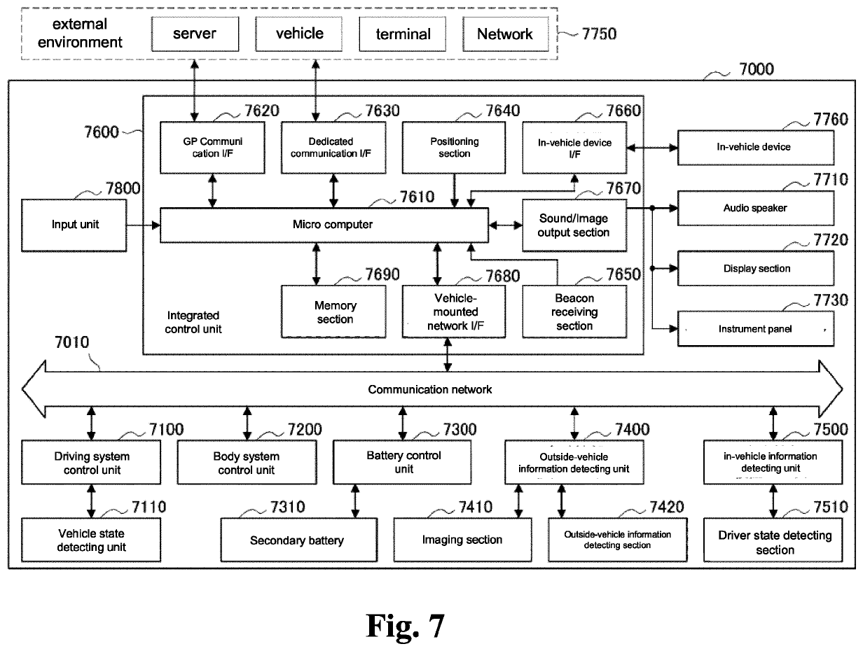

FIG. 7 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 7, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 7 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110.

The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 comprises an imaging assembly according to the present invention and may further comprise a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

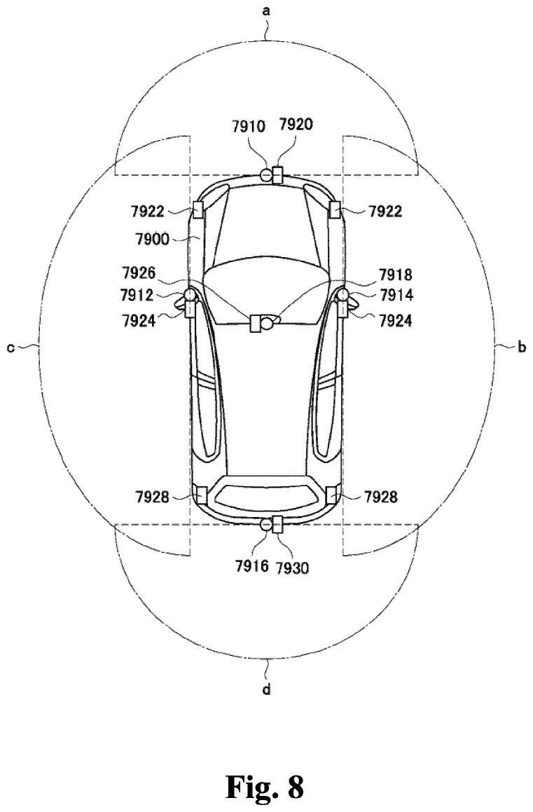

FIG. 8 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like. The imaging sections 7910, 7912, 7914, 7916, and 7918 may be provided including an imaging assembly including the imaging sensor device 1.

Incidentally, FIG. 8 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device.

The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 7, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, at least part of the constituent elements of the imaging sensor device 1,11,12 described with reference to FIG. 1, FIG. 2 and FIG. 3 or of the imaging assembly according to the present disclosure may be implemented in a module.

Note that the present technology can also be configured as described below.
(1) Imaging sensor device 1 configured to produce image data 300,301 comprising a plurality of analog-to-digital-converters 20, a pixel array 200 comprising a plurality of pixels 30 in a row 110 and column 111 arrangement, the pixels 30 being of at least two different types, at least one type of pixels being a type of IR-pixels 50 and at least one type of pixels 30 being a type of non-IR-pixels, the types of IR-pixels 50 being configured to primarily sense infrared light, the types of non-IR-pixels being configured to primarily sense electromagnetic radiation that is not infrared light, a connection 60 between individual pixels 30 and the individual analog-to-digital-converters 20 being configured to provide a plurality of selectable channels, a first channel causing the plurality of analog-to-digital-converters 20 to access the plurality of pixels 30 as pixels being accessed, a second channel causing the plurality of analog-to-digital-converters 20 to access only pixels 30 of a type of IR-pixels 50 as pixels being accessed.
(2) Imaging sensor device 1 according to (1), the diversity of types of pixels 30 further comprising a plurality of types of visual pixels 40, the types of visual pixels 40 being configured to sense visual light.
(3) Imaging sensor device 1 according any of (1) or (2), the types of visual pixels 40 comprising a red type 41, configured to sense a red component of visual light, a green type 42, configured to sense a green component of visual light and a blue type 43, configured to sense a blue component of visual light, as RGB pixels.
(4) Imaging sensor device 1 according to any of (1) to (3), the connection 60 comprising wires 62.
(5) Imaging sensor device 1 according to any of (1) to (4) the connection 60 providing for each analog-to-digital-converter 20 to be cross-connected to pixels 30 in at least two adjacent columns 111 of pixels 30.
(6) Imaging sensor device 1 according to any of (1) to (5), the connection 60 further comprising switches 63, a channel of the plurality of selectable channels determining a state of the switches 63, the state of the switches 63 setting the pixels being accessed.
(7) Imaging sensor device 1 according to any of (1) to (6), the pixels 30 in at least two different columns 111 of pixels 30 comprising at least one type of IR-pixels 50 and one type of non-IR-pixels.
(8) Imaging sensor device 1 according to any of (1) to (7), the connection 60 further comprising a plurality of multiplex devices 70, a channel of the plurality of selectable channels determining a state of the multiplex devices 70, the state of the multiplex devices 70 setting the pixels being accessed.
(9) Imaging sensor device 1 according to any of (1) to (8), each individual multiplex device 70 being connected to an associated cell of analog-to-digital-converters 20, each associated cell of analog-to-digital-converters 20 comprising an even number of at least four analog-to-digital-converters 20, each analog-to-digital-converter 20 comprising an associated cell of analog-to-digital-converters 30 being connected to the output of the multiplex 70 device in a parallel arrangement.
(10) Imaging sensor device 1 according any of (1) to (9), each individual multiplex device 70 being connected to an associated bundle of wires 62, each associated bundle of wires comprising a number of wires 62 that is twice the number of analog-to-digital-converters 20 constituting the associated cell of analog-to-digital-converters 20.
(11) Imaging sensor device 1 according to any of (1) to (10), the associated bundle of wires 62 being connected to pixels 30 in a number of columns 111, the number of columns 111 being half the number of analog-to-digital-converters 20 constituting the associated cell of analog-to-digital-converters 20, the columns being adjacent to each other.
(12) Imaging sensor device 1 according to any of (1) to (11), the plurality of analog-to-digital-converters 20 being configured to read a state of the pixels being accessed in a sequence column-by-column and row-by-row.
(13) Imaging sensor device 1 according to any of (1) to (12), the sequence constituting a rolling shutter procedure.
(14) Imaging sensor device 1 according to any of (1) to (13), the plurality of selectable channels including a channel that causes the plurality of analog-to-digital-converters 20 to access only a subset of the plurality of pixels 30 as pixels being accessed, the subset of the plurality of pixels comprising no types of IR-pixels 50, or the subset of the plurality of pixels comprising types of IR-pixels 50 and types of non-IR-pixels.
(15) Control method for controlling an imaging sensor device 1, comprising setting a connection 60 between pixels and analog-to-digital-converters 20 to one of a plurality of channels, a first channel causing the plurality of analog-to-digital-converters 20 to access the plurality of pixels 30 as pixels being accessed, a second channel causing the plurality of analog-to-digital-converters 20 to access only IR-pixels 50 as pixels being accessed, reading a state of the pixels being accessed to produce image data 300,301.
(16) Imaging sensor device control method according to (15), the plurality of selectable channels including a channel that causes the plurality of analog-to-digital-converters 20 to access only a subset of the plurality of as pixels 30 being accessed, the subset of the plurality of pixels comprising no types of IR-pixels 50, or the subset of the plurality of pixels comprising types of IR-pixels 50 and types of non-IR-pixels.
(17) Imaging sensor device control method according to any of (15) or (16), the plurality of analog-to-digital-converters 20 being configured to read a state of the pixels being accessed in a sequence column-by-column and row-by-row.
(18) Imaging sensor device according to any of (15) to (17), the sequence constituting a rolling shutter procedure.
(19) Imaging assembly including the imaging sensor device 1 according any of (1) to (14).
(20) Vehicle 7900 including the imaging assembly according to (19).
(21) A computer program comprising program code causing a computer to perform the method according to anyone of (15) or (18), when being carried out on a computer.
(22) A non-transitory computer-readable recording medium that stores therein a computer program product, which, when executed by a processor, causes the method according to anyone of (15) to (18) to be performed.

### LIST OF REFERENCE SIGNS

1 Imaging sensor device
30 Pixel
40 Visual pixel
41 Red type pixel
42 Green type pixel
43 Blue type pixel
50 IR-pixel
60 Connection
61 Cross-connection
62 Wire
63 Switch
64 Column wire
70 Multiplex device
100 ADC array
200 Pixel array
301 Image data
300 Image data
7000 Vehicle control system
7010 Communication network
7100 Driving control system
7110 Vehicle state detecting unit
7200 Body system control unit
7300 Battery control unit
7310 Secondary battery
7400 Outside vehicle information detecting unit
7420 Outside vehicle information detecting section
7500 In-vehicle information detecting unit
7510 Driver state detecting section
7600 Integrated control unit
7610 Micro-computer
7620 GP Communication I/F
7630 Dedicated Communication I/F
7640 Positioning Section
7650 Beacon receiving section
7660 In-vehicle device I/F
7670 Sound/Image output section
7680 Vehicle-mounted network I/F
7690 Memory section
7710 Audio speaker
7720 Display section
7730 Instrument panel
7750 External environment
7800 Input unit
7900 Vehicle
7910 Imaging section
7912 Imaging section
7914 Imaging section
7916 Imaging section
7918 Imaging section
7920 Outside-vehicle information detecting section
7922 Outside-vehicle information detecting section
7924 Outside-vehicle information detecting section
7926 Outside-vehicle information detecting section
7928 Outside-vehicle information detecting section
7930 Outside-vehicle information detecting section

1. Imaging sensor device configured to produce image data comprising a plurality of analog-to-digital-converters;
a pixel array comprising a plurality of pixels in a row and column arrangement;
the pixels being of at least two different types;
at least one type of pixels being a type of IR-pixels and at least one type of pixels being a type of non-IR-pixels;
the types of IR-pixels being configured to primarily sense infrared light;
the types of non-IR-pixels being configured to primarily sense electromagnetic radiation that is not infrared light;
a connection between individual pixels and the individual analog-to-digital-converters being configured to provide a plurality of selectable channels;
a first channel causing the plurality of analog-to-digital-converters to access the plurality of pixels as pixels being accessed;
a second channel causing the plurality of analog-to-digital-converters to access only pixels of a type of IR-pixels as pixels being accessed.

2. Imaging sensor device according to claim 1, the diversity of types of pixels further comprising a plurality of types of visual pixels;
the types of visual pixels being configured to sense visual light.

3. Imaging sensor device according to claim 2,
the types of visual pixels comprising a red type, configured to sense a red component of visual light, a green type, configured to sense a green component of visual light and a blue type, configured to sense a blue component of visual light, as RGB pixels.

4. Imaging sensor device according to claim 1, the connection comprising wires.

5. Imaging sensor device according to claim 1,
the connection providing for each analog-to-digital-converter to be cross-connected to pixels in at least two adjacent columns of pixels.

6. Imaging sensor device according to claim 5,
the connection further comprising switches;
a channel of the plurality of selectable channels determining a state of the switches;
the state of the switches setting the pixels being accessed.

7. Imaging sensor device according to claim 1,
the pixels in at least two different columns of pixels comprising at least one type of IR-pixels and one type of non-IR-pixels.

8. Imaging sensor device according to claim 1, the connection further comprising
a plurality of multiplex devices;
a channel of the plurality of selectable channels determining a state of the multiplex devices;
the state of the multiplex devices setting the pixels being accessed.

9. Imaging sensor device according to claim 4,
each individual multiplex device being connected to an associated cell of analog-to-digital-converters;
each associated cell of analog-to-digital-converters comprising an even number of at least four analog-to-digital-converters;
each analog-to-digital-converter comprising an associated cell of analog-to-digital-converters being connected to the output of the multiplex device in a parallel arrangement.

10. Imaging sensor device according to claim 9, each individual multiplex device being connected to an associated bundle of wires;
each associated bundle of wires comprising a number of wires that is twice the number of analog-to-digital-converters constituting the associated cell of analog-to-digital-converters.

11. Imaging sensor device according to claim 10,
the associated bundle of wires being connected to pixels in a number of columns, the number of columns being half the number of analog-to-digital-converters constituting the associated cell of analog-to-digital-converters;
the columns being adjacent to each other.

12. Imaging sensor device according to claim 1,
the plurality of analog-to-digital-converters being configured to read a state of the pixels being accessed in a sequence column-by-column row-by-row.

13. Imaging sensor device according to claim 12,
the sequence constituting a rolling shutter procedure.

14. Imaging sensor device according to claim 1,
the plurality of selectable channels including a channel that causes the plurality of analog-to-digital-converters to access only a subset of the plurality of pixels as pixels being accessed,
the subset of the plurality of pixels comprising no types of IR-pixels; or
the subset of the plurality of pixels comprising types of IR-pixels and types of non-IR-pixels.

15. Control method for controlling an imaging sensor device, comprising
setting a connection between pixels and analog-to-digital-converters to one of a plurality of channels;
a first channel causing the plurality of analog-to-digital-converters to access the plurality of pixels as pixels being accessed;
a second channel causing the plurality of analog-to-digital-converters to access only IR-pixels as pixels being accessed,
reading a state of the pixels being accessed to produce image data.

16. Imaging sensor device control method according to claim 15,
the plurality of selectable channels including a channel that causes the plurality of analog-to-digital-converters to access only a subset of the plurality of as pixels being accessed,
the subset of the plurality of pixels comprising no types of IR-pixels; or
the subset of the plurality of pixels comprising types of IR-pixels and types of non-IR-pixels.

17. Imaging sensor device control method according to claim 15,
the plurality of analog-to-digital-converters being configured to read a state of the pixels being accessed in a sequence column-by-column and row-by-row.

18. Imaging sensor device according to claim 17,
the sequence constituting a rolling shutter procedure.

19. Imaging assembly including the imaging sensor device according to claim 1.

20. Vehicle including the imaging assembly according to claim 19.
